(19) United States
(12) Patent Application Publication
(10) Pub. No.: US 2012/0187693 A1
(43) Pub. Date: Jul. 26, 2012

(54) HYDROKINETIC ENERGY TRANSFER DEVICE AND METHOD

(76) Inventors: Robert C. Houvener, Hollis, NH (US); Tyler Nathaniel Doyle, Marblehead, MA (US)

(21) Appl. No.: 13/272,482

(22) Filed: Oct. 13, 2011

Related U.S. Application Data
(60) Provisional application No. 61/392,724, filed on Oct. 13, 2010.

(51) Int. Cl. F03B 13/10; F03D 11/04; F03D 9/00; F03D 1/06

(52) U.S. Cl. 290/54; 416/93 R; 416/85

(57) ABSTRACT

A device configured for the production of hydrokinetic energy that allows the efficient capture of energy from fluid in motion, especially slow flowing fluids. The device features an innovative structural design and drive train system as well as redundancy, which allows the device to be deployed in position, placed in service and maintained over its lifetime through the use of remotely operated vehicles. The device features one or more turbines, each turbine having an open center tube. The device features a buoyancy system including a plurality of thin walled modular buoyancy chambers with a redundant (re)pressurization system and remotely operated vehicle replaceable bladder modules. Structure cavities of the device are capable of storing energy via processed energy storage liquids such as hydrogen or via gas compression in tanks and then exporting the stored energy or reconverting the stored energy into electricity.

### CROSS-REFERENCE TO RELATED APPLICATIONS

This application claims priority to U.S. Provisional Patent Application No. 61/392,724 filed on Oct. 13, 2010 entitled “Hydrokinetic Energy Transfer Device and Method”, of which is incorporated fully herein by reference.

### TECHNICAL FIELD

The present invention relates to hydrokinetic energy and more particularly, relates to a device that allows efficient capture of energy from fluid in motion, especially slow flowing fluids and to a device having an innovative structural design and drive train system which features allow the reduced cost device to be easily and innovatively deployed in position, placed in service and maintained over its lifetime.

### BACKGROUND INFORMATION

Hydrokinetic power or energy utilizes the natural flow of water (or in the case of air this would be aerokinetic energy, such as wind turbines) such as tidal water, rivers, ocean currents, etc., to generate electricity. As used herein, for the most part and where technically applicable, the term hydrokinetic shall include aerokinetic as well. Hydrokinetic energy does not involve creating “head” utilizing dams or other water flow blocking structures but rather, involves extracting energy from very low velocity flows. Hydrokinetic power is therefore very ecologically friendly.

All the various configurations of hydrokinetic energy capture devices in the prior art suffer from one or more major flaws. First of all, efficient systems have been of very small design that do not scale well to a larger design. Those larger designs that have been tried are inefficient with a very high cost per kilowatt hour and inefficient use of the flow resource. All systems have suffered from difficult installation challenges. Moreover, most of the prior art systems need a relatively fast current (approximately 3+ m/s) to be semi-viable, even with government subsidies.

Accordingly, given the cost of the prior art devices, their inefficiency and the cost of installing the devices, the energy they can extract from the fluid motion and later used for purposes such as electricity generation is not cost competitive with other methods of extracting energy and utilizing it for purposes such as electricity generation, water desalinization and hydrogen or other chemical production.

For example, a coal fired power plant has a cost of electricity (COE) of around 4-5 cents per kilowatt hour, whereas the best hydrokinetic device has a COE in the 20-30 cents range, in very fast flow velocities. At this point, no renewable power source, which can scale to industrial power levels (wind, solar, geothermal, etc.), has shown that it can match the COE of current methods of generating electricity by extracting energy from fossil fuels.

One key problem in designing a viable large hydrokinetic turbine is the size, mass, cross sectional area and complexity of the drive train and supporting structure. Modern hydrokinetic turbines generally take one of two approaches to the turbine structure. The first approach is an un-ducted turbine and the second is a ducted turbine. Un-ducted turbines generally utilize a drive train design wherein the rather slowly turning rotor is attached to a high ratio gearbox, which is then in turn connected to a high speed generator. Some ducted turbines utilize the same rotor-high speed gearbox—generator design as is commonly utilized in the un-ducted turbines, but many utilize a direct drive generator, without a gearbox. Whether used in the ducted or un-ducted turbine, when a direct drive generator is utilized, its size and weight are generally many times larger than those utilizing the intermediate gearbox between the rotor and generator. This much larger generator utilizes significantly more material, including rare earth magnetic materials, which are in short supply and pose a national security problem, as most of it is mined in China, who is rationing the supply to global markets and keeping much of its production for internal uses. Although the high ratio gearbox has been shown to be a key reliability issue for these systems, for cost, weight and size requirements, this drive train is still the predominant one used in hydrokinetic devices, as well as modern wind turbines.

Using the Electric Power Research Institute's (EPRI) energy conversion methodology, the instantaneous power that can be generated from flowing water by an underwater, hydrokinetic turbine is given by

P_{hydrokinetic-turbine}=η_{w-w}0.5ρAU³ Equation (1)

where P is power in [W], A is the cross-sectional area of flow intercepted by the device, i.e. the area swept by the turbine rotor in [m²], ρ is the water density (1,000 kg/m³ for freshwater and 1,025 kg/m³ for seawater), U is current speed in [m/s] and n_{w-w} is the “water-to-wire” efficiency, the product of all system efficiencies (rotor coefficient of performance, gearbox/generator efficiencies). There are other factors such as current velocity variation with depth, turbulence, etc—but this is the fundamental driving equation for today's systems.

Most prior art hydrokinetic systems are optimizing for U, the current speed, i.e., they are designing heavy, armored systems to be deployed in very fast 3+ m/s flows, which are a tiny fraction of the current flows in the world. What is necessary, therefore, is a design that is optimized for both A and U, i.e. design scalability to enable increased swept area, with a cost effective and moderate weight drive train and an efficiency enhancing structural design so that it can cost-effectively utilize slower, less violent and much more predominant global current flows.

Accordingly, what is needed is a low cost approach to Hydrokinetic power that scales from a few Kw to Mw's per system and due to its inherent efficiency at extracting energy from fluid motion, enables the extraction of energy from renewable sources, with no carbon footprint, at COE's that are at parity or better than the COE of coal, the lowest current COE generation method.

### SUMMARY

The present invention combines a novel, efficiency enhancing, light weight and low cost central structure and buoyancy system with a novel low cost, and highly reliable drive train in an innovative system design to create a large, but relatively light-weight hydrokinetic turbine that achieves disruptively low deployment cost and low Cost of Electricity (COE), in high volumetric flow rate, low velocity (1-3 m/s) marine currents. This same innovation is directly applicable to wind turbines, most especially, off-shore wind turbines, where efficiency, weight, reliability, cost (capital, deployment and O&M) and scalability are keys to competitive COE. Such a system dramatically opens up the scope of large, low velocity currents world-wide that are viable for use in cost competitive hydrokinetic electricity generation in ocean and tidal currents and potentially rivers.

The present invention solves the problem of the use of large mass, direct drive permanent magnet drive trains by achieving high reliability via its alternative drive train approach. This innovation utilizes a relatively large hollow tube as the main structural component of the turbine. The rotor system is mounted to and rotates around this tube, utilizing low friction, high reliability and very high torque bearing surfaces such as are used in ship propeller shafts and very large conventional hydro dam turbines. The innovative drive train utilizes a gear that is directly attached to the large diameter rotor structure and is therefore inherently of a very large diameter in this overall turbine design. This large but relatively light weight gear, when mated with a much smaller gear on a gearbox (or directly to a generator in some cases), provides a significant speed ratio increase on the front end, prior to the gearbox (nominally 20:1), in a highly reliable and low cost and light weight mechanism. This speed up allows the use of a very simple (nominally 10:1, single stage), low cost and highly reliable gearbox on the front end of the generator and the use of low cost, moderately high speed (500-2000 rpm) and relatively light weight generator. The gearing system between the large tube and the shaft on the gearbox can be a silent chain, meshing gear, tire based gearing or other mechanism. For example, when compared to a generator/drive train system in a conventional direct drive hydrokinetic (or wind) turbine, this innovation will be on the order of 20-30% the cost, similar reliability, and 20-30% of the volume and weight. For example, a direct drive 4.25 megawatt wind turbine generator from The Switch, Vantaa, Finland, weighs approximately 85 tons; while in the present invention, that same capability would weigh approximately 15-20 tons. The 60-70 ton weight savings gets multiplied many times at the platform level for off-shore floating wind, when the benefits to the rest of the structure, from having less weight at the top of the tower are factored in. The benefits of this in terms of the COE at the system level is highly disruptive, potentially bringing it down to 25-50% of the COE of competitive systems targeted at slow (1-3 m/s) marine currents, as well as off-shore wind turbines.

### BRIEF DESCRIPTION OF THE DRAWINGS

These and other features and advantages of the present invention will be better understood by reading the following detailed description, taken together with the drawings wherein:

FIG. 1 is a detailed view of a monopole tripod mounted turbine with rigid bottom mounted rotating thrust offsetting buoyancy tank;

FIG. 2 is a detailed view of a main turbine support tube, rotor and generation elements;

FIG. 3 is a rear view of turbine core;

FIG. 4 is a rear view with blades and shroud;

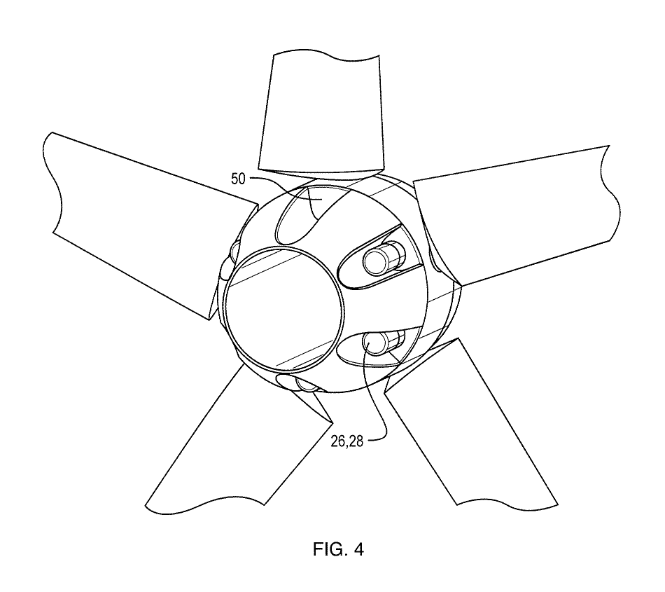

FIG. 5 is a detailed view of a rotor with main gear and bearing;

FIG. 6 is a transparent side view of turbine;

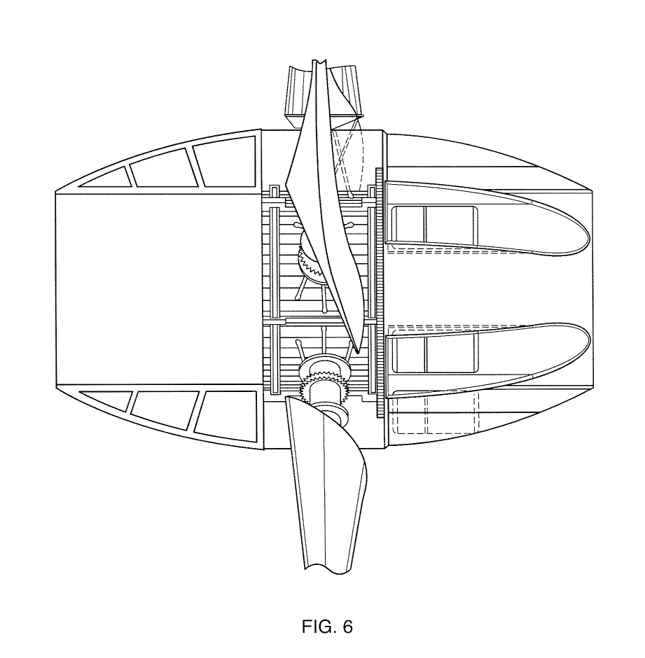

FIG. 7 is a detailed view of a turbine with ballast weight;

FIG. 8 is a detailed view of a hybrid hydrodynamic and buoyancy controlled turbine structure;

FIG. 9 is a detailed view of an open center hydrokinetic turbine and depth control wing;

FIG. 10 is a detailed view of a hybrid mast and suction pile base;

FIG. 11 is a detailed view of a hybrid mast and networked redundant membrane buoyancy system;

FIG. 12 is a detailed view of a redundant membrane buoyancy system with flexible membrane mid mount rotating thrust offsetting buoyancy tank;

FIG. 13 is a detailed view of a legacy stabilized platform designs;

FIG. 14 is a detailed view of a redundant membrane buoyancy system with streamlined, highly secure buoyancy mounting;

FIG. 15 is a detailed view of a deployed kinetic energy conversion system with structure, mooring, support vessel and ROV;

FIG. 16 is a detailed view of fluting effects of open center unducted turbine;

FIG. 17 is a detailed view of a yoke based mooring;

FIG. 18 is a detailed view of a daisy chain mooring;

FIG. 19 is a detailed view of a hinge based mooring;

FIG. 20 is a detailed view of a semi rigid ambient floodable buoyancy chamber;

FIG. 21 is a detailed view of a modular semi rigid ambient floodable buoyancy chamber; and

FIG. 22 is a detailed view of buoyancy chambers for use during deployment.

### DETAILED DESCRIPTION OF THE PREFERRED EMBODIMENTS

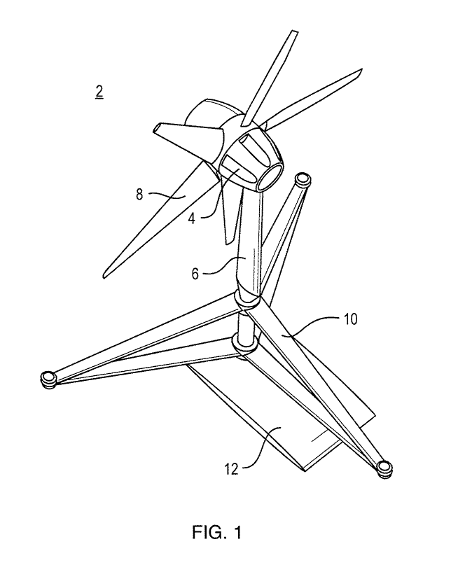

FIG. 1 shows one embodiment of the hydrokinetic device 2 of the present invention which includes a turbine body 4, to which is attached a turbine tower (or mast) 6. Also attached to the turbine body 4 is a set of blades 8, which are up stream of the tower 6 in this embodiment, but can also be downstream. In addition, this embodiment shows a tripod structure 10 and rotating buoyancy chamber 12, wherein the tower 6 rotates within the tripod 10 and rigidly connects the turbine body 4 to the chamber 12, which innovation may be utilized to offset the thrust imparted on the structure by the turbine body 4 via the tower 6. By utilizing the rotating chamber 12 to apply counteracting force, directly opposite of the force from the flow of fluid on the turbine components, less buoyancy overall must be provided and hence lower overall structural material use and cost results, especially in implementations such as supporting offshore floating wind turbines.

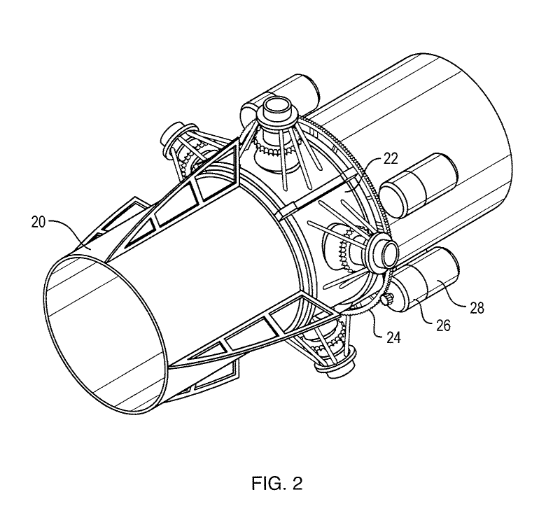

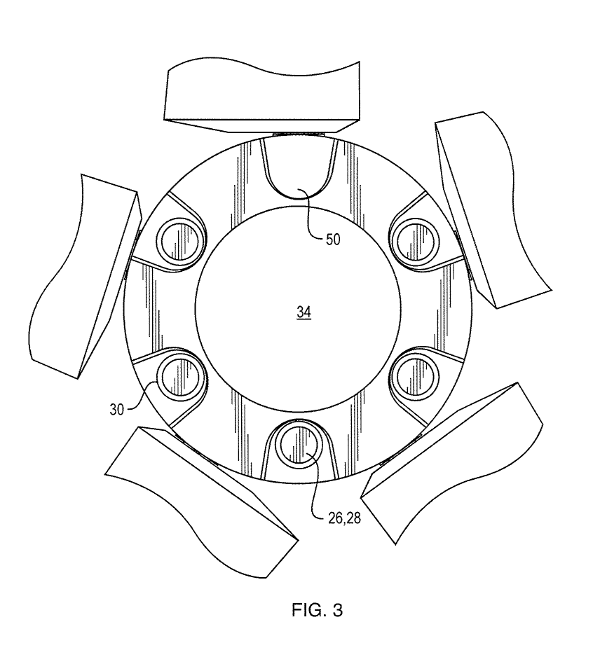

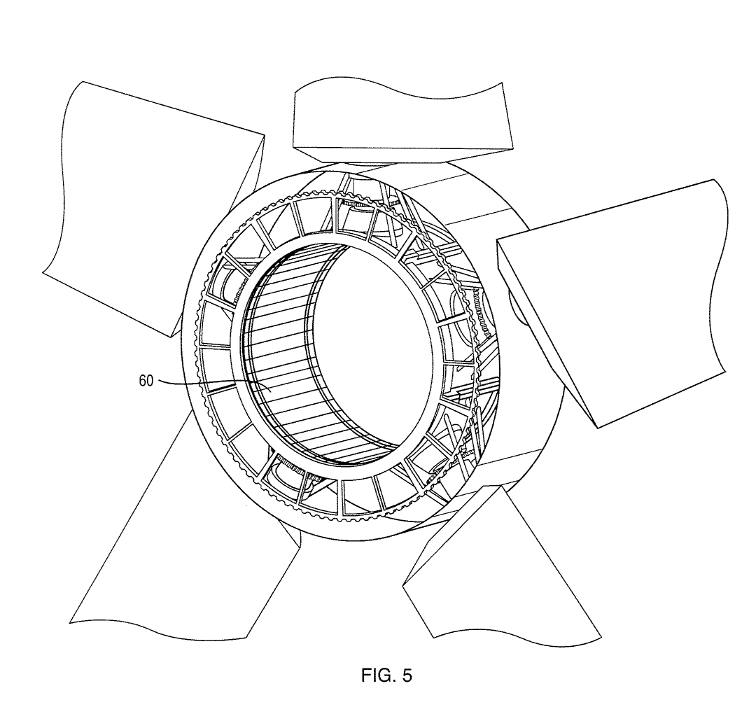

A cut away view of the turbine body 2 is shown in FIG. 2. Unlike legacy turbines which are designed as shafts, the turbine of FIG. 2 has neither a small diameter set of solid central shafts and related bearings and cast mounting structures, as most un-ducted turbines, such as the Marine Current Turbines—SeaGen unit, utilize, nor a rim mounting system as many ducted turbines, such as the Open Hydro turbine, utilize. Instead, this system utilizes a unique and innovative high strength hollow tube 20 such as those made of steel or composite fiber reinforced plastic, as its core structural member, with the rotor 22 riding on the tube 20 via a high strength, low friction bearing surface 60 (FIG. 5). This design has many advantages when compared to either a solid shaft design or a ducted rim connected design. The first advantage is that the tube design leaves the center of the turbines swept area 34 (FIG. 3) open for fluid to flow through, unobstructed, which significantly improves the flow of fluid through the blades, by helping to remove de-energized fluid that has already had energy extracted from it, from the back (downstream) of the turbine.

In alternate embodiments of the present invention, this hollow tube can have various shapes of guide vanes installed, in order to provide redirection of the flowing water and even greater effect in enhancing the overall efficiency of the turbine, as well as providing counter torque in the turbine structure. This may yield a conversion efficiency improvement of 1-5 percent at full scale, such as from 42% to 47%, which has a dramatic positive impact of the amount of electricity that the turbine system can generate. Second, the large rotor 22 and large bearing surface 60 (FIG. 5) interfacing with the large tube 20, enables the rotor 22 to withstand much greater loading from the forces applied to the turbine during operation, without over stressing the rotor 22 or surrounding structure, all with a moderate weight structure. Third, the design enables the use of a very large diameter, but a low weight main gear 24, which is some 5% to 20% larger than the diameter of the tube 20, is directly attached to the rotor 22 and is designed to support the vanes and to spin around the hollow tube 20. This large but light weight gear 24, enables the use of simple, potentially single stage and very reliable gearboxes 26 and the use of relatively small, low cost and highly reliable generators 28, such as marinized versions of the Danotek Motion Products permanent magnet generators. In some instances, such as moderate velocity wind, or smaller diameter turbines in general, the RPM of the rotor will enable the elimination of the gearbox all together, further reducing weight and cost, and increasing reliability.

The generator 28 and gearbox 26, mount to the tube 20 and are field replaceable modules, which in some embodiments are made near neutrally buoyant by adding buoyancy to the generator/gearbox module, such as for example buoyancy from Floatation Technologies of Maine, which maintains essentially the same buoyancy over significant depth ranges, in order to enable replacement via Remotely Operated under water Vehicles (ROV's) 140, thereby significantly reducing O&M costs. This unique design allows the use of these low cost generators 28 and gearboxes 26 in systems that have very low rotational speeds, as low as 2-3 rpm's. In order to facilitate replacement by ROV's, the generator 28 and gearbox 26 modules utilize ROV friendly locking and extraction mechanisms and the power and other connections utilize automated connectors that can be plugged and unplugged under water, such as those of Teledyne and SeaCon. Most importantly, although larger diameter turbines spin at a slower rate, the fact that the tube 20 would be larger on larger turbines while at the same time the turbine rpm would be lower on larger turbines, enables the use of the same generator/gearbox assembly for multiple sizes of turbines, thereby reducing design costs and facilitating production and maintenance of the systems. In addition to the generator 28 and gearbox 26 module, a very similar module, with the same plug and play capabilities 30, houses all other electronics such as but not limited to one or more of power conditioners, voltage regulators, voltage multipliers and control electronics. As shown in FIG. 3, multiple generator 28/gearbox 26 modules and electronics modules 30, can be utilized in order to provide full redundancy and fail over, in order to minimize on-site maintenance and repair, while maximizing system generating up time. For example, in the preferred embodiment of a very high reliability model of the present invention, two fully redundant electronics modules would be utilized and a N+1 (2+1 in FIG. 3) generator architecture would be utilized, so that the failure of components in a generator/gearbox module or an electronics module, would not impact the generation of electricity by the system. In addition, most embodiments of the current invention utilize a braking system in order to slow and stop the rotor when needed. Some implementations may also include a clutch mechanism to engage/disengage individual generators/gearboxes.

In alternate embodiments of the present invention, the generators 28, gearboxes 26 and large gear 24 may be replaced by a direct drive permanent magnet generator, in which one half of the generator core, say the generator rotor, is located on the turbine rotor 22, replacing the gear 24 and the generator stator is placed on the tube 20. This permanent magnet generator could be either of standard construction, utilize permanent magnets, as well as utilize superconducting components for lighter weight and greater efficiency.

The blades 8 connect to the rotor 22 via a blade shaft 40 that fits into a joint 32. The joint allows the rotation of the blade for pitch control and feathering purposes, via legacy mechanisms that are well known in the hydrokinetic and wind turbine industries. The blades are of a nature such as those described in patent application number PCT/US 10/37959 or other blade designs that are suitable for exploiting the unique and innovative features of this invention.

In the preferred embodiment, both the generator 28/gearbox 26 modules and electronics modules 30 plug into an electrical/optical bus that is integrated into the plate 50, which is positively affixed to the tube 20. This enables the modules to communicate between each other, as well as enables the transmission of power from the generators 28 to a common umbilical which is shared by all the modules and connects the turbine to a grid or other user of the electricity that the turbine generates. It also connects the electronic control mechanisms for the turbine to external command and control infrastructure. The bus eliminates the need for point to point wiring and the reliability issues that this causes.

As shown in FIG. 5, the inside surface of the rotor 22 in the preferred embodiment, is partially lined with bearing material 60, which is submerged in the flowing water, in the case of a hydrokinetic turbine. This material can be wood, synthetics or metallic and can be procured from companies such as Ggbearings, Oiles, Thordon Bearings and Vesconite, which supply similar material for use in marine and conventional hydroelectric dam systems. In the preferred embodiment, raw water from the flow of water past the system will provide additional lubrication in these bearings. In other embodiments, a water filtration system and bearing seals are utilized in order to keep particulates out of the bearing. It can also be magnetic, in order to form a magnetic bearing. As noted previously, by utilizing this design, enormous amounts of stress can be spread out on a fairly large surface as compared to legacy hydrokinetic and wind turbine design approaches, thereby reducing the weight, as well as eliminating the high failure rates associated with legacy stress isolation system designs, including gearbox failures. A sleeve, spray on or other surface may be added to the tube 20, so as to enhance the wear characteristics of the tube and the bearing materials.

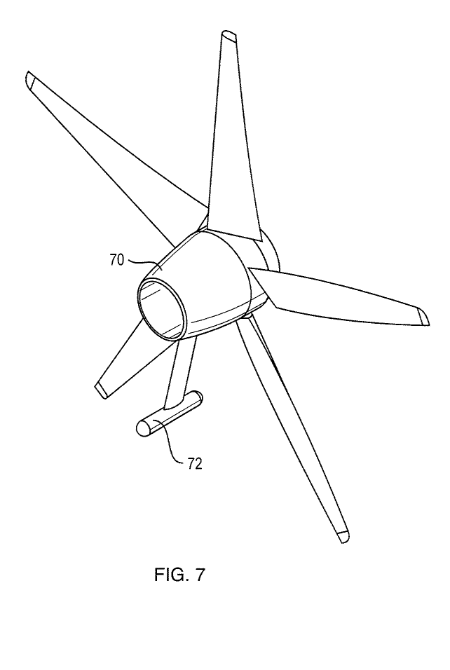

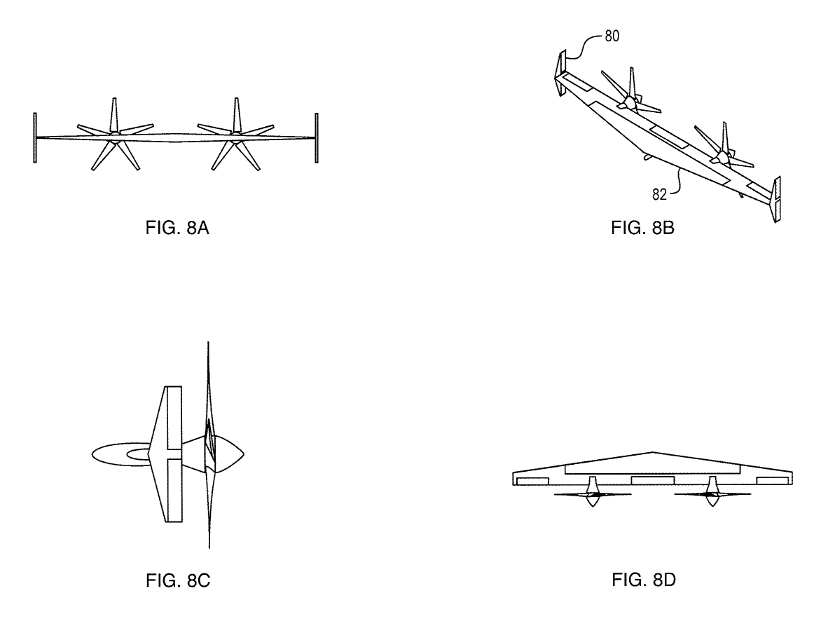

As shown in FIG. 7, a relatively neutrally buoyant turbine configuration can be utilized, in which the buoyancy is provided by providing buoyancy via buoyancy tanks 70 and a counter rotational ballast 72, placed below the center of buoyancy. Further embodiments of deployment structures, such as the wing design 80 shown in FIG. 8, can utilize a combination of hydrofoil surfaces and integrated buoyancy tanks 82, in order to provide the necessary lift, as well as anti-rotational torque capabilities. Such structures can utilize a single turbine, dual counter rotating turbines or more than two turbines, in order to optimize structural cost and deployment efficiency, among other factors influencing COE.

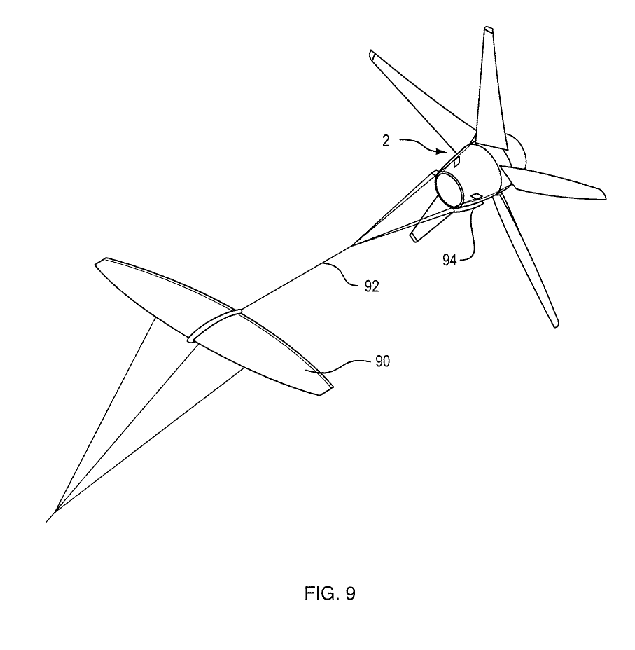

A further innovative embodiment of the structural design, as shown in FIG. 9, separates the turbine 2, from the thrust compensation hydrodynamic surface 90 and connects them via cable 92. This embodiment has the advantage that the thrust compensation mechanism can be quite far up stream of the turbine, thereby reducing the negative effects on the flow that is intersecting the turbine, thereby increasing the efficiency of the turbine. The trade off is that the control mechanisms for the overall system are more complex, especially when events such as the total loss of flow, are encountered. Positive control of the structures 2 and 90 can be achieved via the use of further moorings, as well as via thrusters, such as bow thrusters that are used on ships. In addition, ballast 94 can be placed closer to the turbine body, in order to provide a more hydro dynamically clean surface, with the trade off being that much more ballast must be utilized versus the method 72 with a longer lever arm.

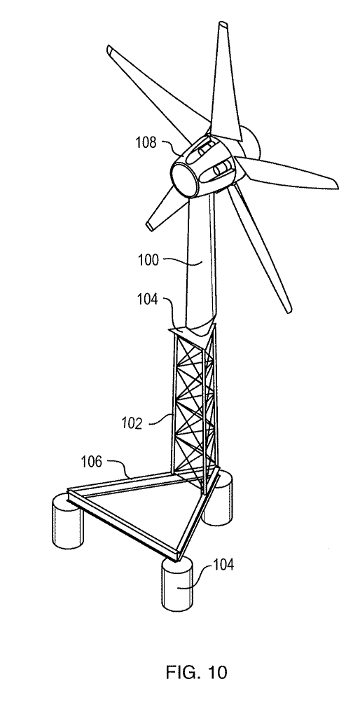

A novel tower mast 100 is utilized in the preferred embodiment, as shown in FIG. 10. This mast is designed in a low drag foil shape, so as to reduce the drag on the overall structure, as well as reduce interference behind the blades 8, which in turn increases the energy conversion efficiency versus legacy tower designs. In addition, this low drag foil helps to accurately position the turbine in the main direction of the flow, by action of the flow on the sides of the foil.

Unlike legacy foil shaped towers, in one embodiment of this invention, the mast is rigidly connected to the turbine at the intersection point 108. The foil shaped mast connects to a reduced cost lattice structure mast component 102, near the endpoint of the blade radius, where blade interference is no longer a problem. At the connection point 104 of the foil shaped mast and the lattice mast, a drive mechanism and rotary slip joints, well known in the hydrokinetic and wind turbine markets, can be utilized to provide rotational (yaw) control, as well as electrical and optical connection for the turbine. The yaw control mechanism can be utilized for both precision pointing of the turbine into semi unidirectional flows as are seen in ocean and river currents, as well as semi-bi-directional flows, as seen in tidal and similar flow regimes.

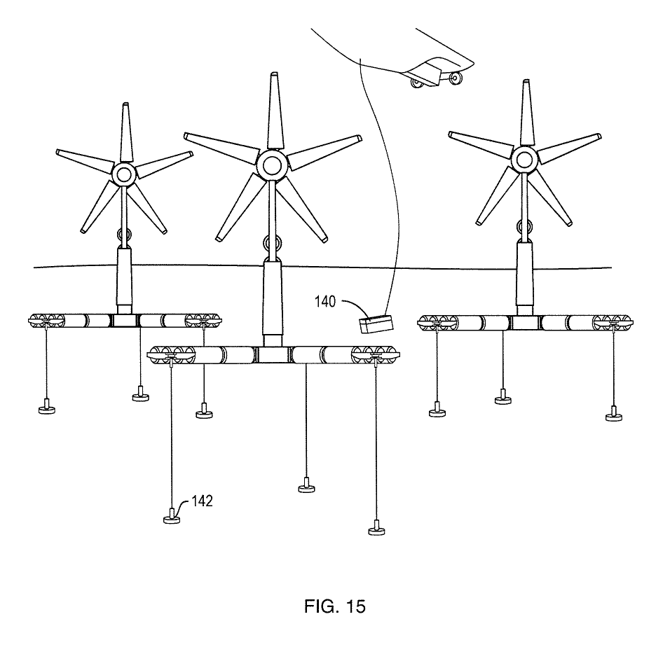

By positioning the yaw control at the bottom of the foil shaped tower, weight is reduced at the top of the structure, which has great benefits in reducing loads induced by weight at the top of the tower on other parts of the structure, especially in the case of off-shore wind turbines and floating turbine structures in particular. In addition, similar offset buoyancy control mechanisms as shown in FIG. 1, can be utilized in this embodiment, in order to reduce overall structural loads, with related costs. In this embodiment, the lattice structure 102 connects to the base 106 trusses and the whole structure is secured to the sea floor via an anchoring mechanism such as suction piles 104 (FIG. 10)/142 (FIG. 15). Suction Piles are sections of pipe, with one end capped and one end open, which are deployed by literally sucking the water out of the pipe after it has been partially sunk into the seabed. As the waster is removed from the pipe, the pipe is sucked into the earth, providing a piling for anchoring purposes.

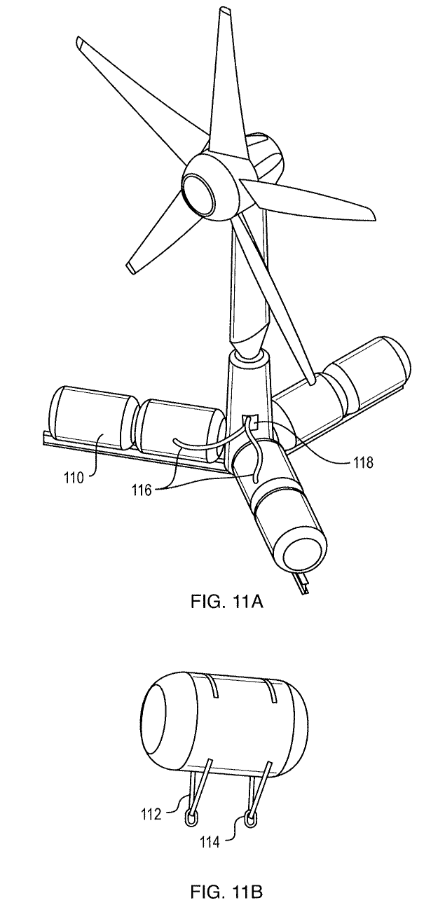

Although the embodiment in FIG. 10 is suitable for shallow water locations, it is not suitable for the vast majority of locations with 1-3 m/s current flows, where depths are greater than 80-100 meters, including ocean currents. For these deeper locations, as well as shallower locations where site characteristics are not suitable for the base 106/104 anchoring design of FIG. 10, a unique and innovative solution is shown in FIG. 11. Legacy embodiments of the design shown in FIG. 11, commonly known as a Tension Leg Platform (TLP) suffer from a fundamental and in most cases catastrophic economic failure, namely, the cost of the structure. Only in very high margin businesses such as offshore oil and gas production and exploration, are they economically feasible. In these designs, such as that outlined in NREL/CP-500-3474, of an offshore wind turbine TLP support structure, the cost of the materials needed in the basic design, drive the cost and weight of the structure to the point that COE is non-competitive. In analyzing NREL/MIT and other industry research, it is evident that the key cost driver in these non-economically feasible TLP designs is the cost of structural materials used to provide the massive buoyancy needs of 100's of tons of buoyancy. This said there are no platform designs of any type on the market or being openly discussed, that are economically feasible, in providing the support structure for floating wind turbines or hydrokinetic devices. Intensive research is on-going in this area, supported by the US DOE, as well as states such as Maine, through the University of Maine. In addition, foreign countries and corporations, such as StatOil with its HyWind spire (estimated cost in the tens of millions of dollars per wind turbine platform), are also heavily investing in trying to solve this problem.

As shown in FIG. 11, a preferred embodiment of the present invention, utilizes an innovative and highly cost effective networked redundant distributed membrane based TLP platform buoyancy control system. Unlike legacy TLP buoyancy control systems that are designed around thick steel or other rigid pressure vessels; the present invention utilizes a suspended network of long life underwater flexible synthetic composite bladders to provide a significant amount of its lift requirement. These bladders are similar to the subsea salvage lift bags manufactured by SubSalve of Rhode Island. Although the SubSalve bladders are not utilized for long duration use, specific design enhancements including materials selection, anchoring mechanisms/designs, backup air (gas) replenishment and redundant buoyancy capacity in the current invention make feasible the use of distributed membranes with 10-20 year useful lifetimes. In above water applications, small to large boats such as the Zodiac brand and other rigid hull commercial and military inflatable boats, as well as air ships, have made extensive use of long life air (or other gas, including nitrogen and helium) bladders in their structural construction for decades.

The embodiment of FIG. 11 includes some number of bladders 110, with attachment straps 112, which are connected to a rigid connection point, such as the support member of the structure 114. The bladders can be filled and deflated via a hose 116, which is connected to a gas distribution unit(s) (GDU) 118. The gas distribution unit can be fed gas from on-board cylinders such as ones that are integrated into the cylindrical lower mast segment, an on-board or attached compressor or an off-board supply line. In one embodiment, this tower segment can serve as a pressure tank for holding an energy storage medium, such as anhydrous ammonia as a hydrogen carrier, which can be generated from extra electricity during times of excess power generation via electrolysis and used to produce more electricity by consuming it during times of peak demand or to level out electricity output during tidal cycles.

A fully redundant gas distribution and monitoring system, with dual lines, controllers, attachment points on the bladders and communications and sensor mechanisms is utilized in the preferred embodiment of the buoyancy control system, so as to avoid the need for emergency repair and potential platform loss, should one system fail. By filling a specific bladder with gas, the bladder is inflated, causing the bladder to rise in the water column. By controlling which bladders are inflated, via the computer controlled GDU, the attitude of the overall structure can be maintained. The bladder rise is arrested by the straps 112 since they are anchored to the structure. In an alternate embodiment, the bladders could be fitted such that, once inflated, they would seat underneath the support member so that they would not release from the structure. Once deflated, they would easily drop off, with a possible retention (non-load-bearing) strap. This could simplify the replacement process for an ROV. Inflating the bladders to the appropriate pressure for a given volume provides a given amount of lift. Most importantly, the bladders have a huge lift per dollar and lift per given weight ratio, both of which are much higher than other pressure vessels, such as steel.

For example, the SubSalve model PF 70000, provides 77,000 lbs of lift, at a cost of $6,000 retail and weighs 410 lbs. FIG. 11 shows a 4000 lb lift SubSalve lift pontoon. This yields a lift per dollar ratio of 77,000/6,000=12.8 lbs per dollar, and a weight per lb of lift ratio of 77,000/410=188 pounds of lift per pound of weight. Importantly, in the present invention, multiple of these bladders are networked in order to provide as much buoyancy as needed, in the case of some versions of the present invention, 100's of tons of lift. As a comparison, in the NREL/MIT optimized off shore wind TLP design 128, the buoyancy mechanism, a steel pressure vessel, weighs approximately 400,000 lbs, would cost $1,000,000 at $2.50 per lb for a fully finished steel prod. In addition to fully flexible membrane materials for bladder construction, other materials such as carbon fiber, fiberglass and other composites may be utilized, in the distributed buoyancy system, in addition to legacy materials, such as steel and concrete, although less benefit is derived from such materials, as they are heavier per unit amount of buoyancy provided.

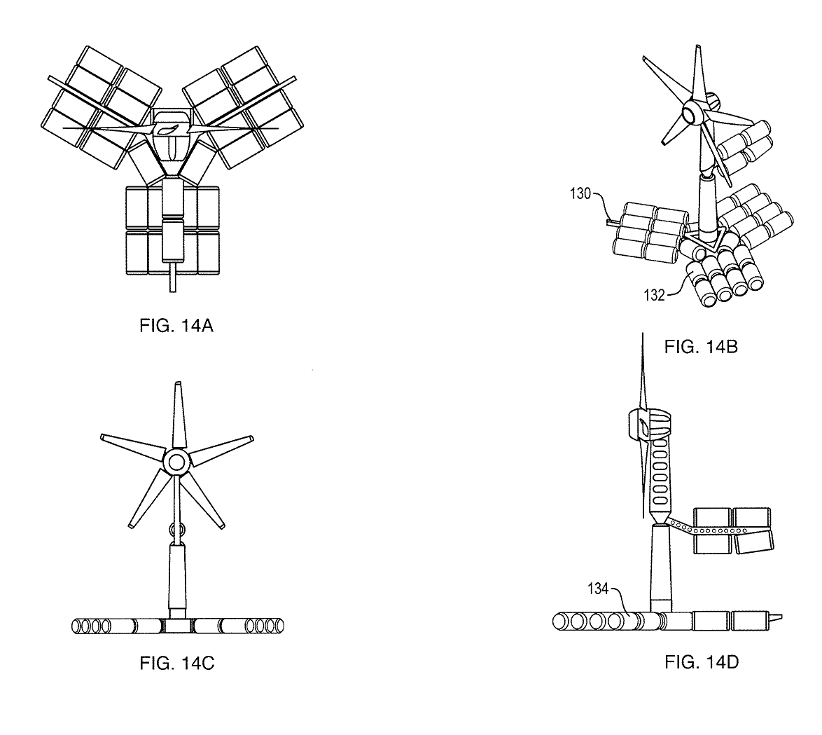

A further embodiment is shown in FIG. 14, wherein the membrane buoyancy bladders 132 are mounted to the structure 130 via a sub frame 134. This design reduces the drag on the overall structure, by reducing the cross section of the buoyancy bladders in the flow of fluid. In addition, it provides further securing of the bladders. In one embodiment, a composite or metallic end cap on the frames further reduces the drag and protects the bladders from wear due to obstructions hitting them.

In a further embodiment (not shown), the ends of the legs 130, may be secured to the non-rotating portion of the mast, thereby reducing loads on the structure. In further embodiment, again not shown, additional sets of leg structures 130 and buoyancy may be mounted vertically, to a downwardly extending central structure, under the first layer of legs and buoyancy, thereby enabling a high degree of scalability in the amount of buoyancy that the invention can provide.

The buoyant platform would provide 4,400,000 lbs. of lift, yielding a lift per dollar ratio of 4,400,000/1,000,000=4.4 lbs per dollar and a weight per lb of lift ratio of 4,400,000/400,000=11 pounds of lift per pound of weight. With the buoyancy being the predominant cost driver in a renewable energy TLP platform, the 12.8:4.4 or approximately 3:1 cost advantage of the current invention's design, to legacy TLP designs, is a major breakthrough in enabling cost effective off-shore energy generation. Even accounting for further lifetime enhancements to the membrane based system, one would expect well greater than a 2:1 cost advantage, and probably closer to 3:1, when the weight advantage is calculated into the overall platform buoyancy need. Also as shown in FIG. 11, rigid hull inflatable boats have used membrane technology to decrease their weight and increase buoyancy, in a long lasting system. As shown, the present inventions weight reducing embodiments can dramatically reduce the overall weight of the system, going from a weight of 500-600 tons down to a weight of approximately 100 tons for a multi-megawatt turbine and structure.

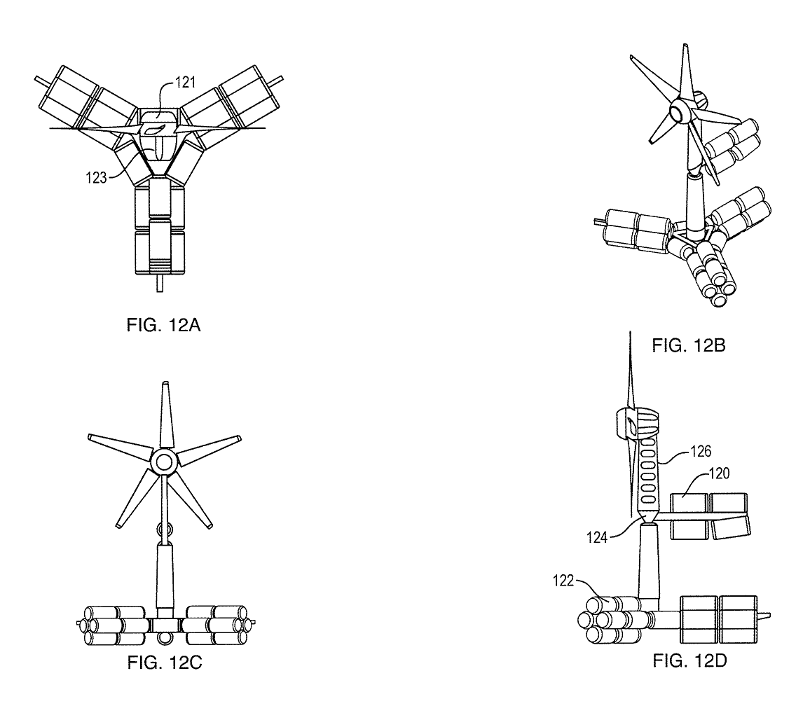

As seen in FIGS. 12 and 14, the membrane bladder buoyancy 120 function can be distributed into smaller bladders 122 and 132 in order to: 1) provide further redundancy and 2) provide additional mounting options on the structure. In addition, in some embodiments, significant portions of the turbine cowling and hydrodynamic enhancing surfaces such as at the upstream 121 and downstream 123 ends of the turbine can be made of membrane and serve as buoyancy control bladders. Unlike other designs that have a one or a smaller number of buoyancy compartments, such as the NREL/MIT TLP, where a loss of pressure in the tank will cause a total loss of the platform, embodiments of the present design can sustain the loss of multiple cells, even ones near each other and still maintain full platform stability and even operation. These bladders can be attached by numerous methods, including cables and straps with locking hooks. In one particularly novel embodiment, the bladders have lengthwise pocket(s), into which a rod is placed, such rod is then locked into a mating mechanism on the platform structure, thereby providing ROV enabled installation and de-installation of the bladders. These rods can be of metallic, composite or other material.

As also shown in FIG. 12, an embodiment of the present invention has the rotating thrust offsetting buoyancy tank system of FIG. 1, implemented with the membrane bladders 120 and in addition, it can be affixed to the rotating tower 126, above the rotational point 124. This provides similar thrust force offsetting capability and similarly reduces the buoyancy need by approximately 50% in the overall structure, versus a system that does not utilize a similar rotating buoyancy thrust offsetting mechanism; this dramatically reduces the weight and cost of the overall structure and system.

Not shown is an embodiment in which a thrust offsetting ballast weight may be utilized in addition to or in place of the rotating thrust offsetting buoyancy tanks, by placing it upstream of the rotor. Further, the end of the rotating tower may be secured to the upper portion of the mast 126, forming a triangle structure, in order to reduce the loads on and weight of the overall structure.

Also not shown, the counter thrust capability noted above may utilize a rigid or flexible foil instead of the non-foil shaped bladders 120, which foil structure may be metallic, composite or membrane and be buoyant, neutral or heavier than the surrounding fluid. Again, those with expertise in the areas of knowledge will recognize the applicability of this novel innovation for other applications such as off-shore wind, as well as other applications which need cost effective but highly stable marine platforms.

A further embodiment of the present membrane buoyancy platform has a hydrokinetic turbine mounted below the membrane platform and a wind turbine mounted above the platform, with the tower of the wind turbine penetrating the water surface. In this dual-use embodiment, a particularly cost effective off shore renewable energy resource is created, which taps not only water currents, but wind currents, in locations that happen to have both of these resources in a given geographic area.

Those with expertise in the ocean engineering field will quickly recognize how this innovation can be applied to platforms other than TLP's, in order to supply long duration and very cost effective platform buoyancy.

The same mechanisms described in FIG. 10 can be utilized in a system that is hard mounted to the underside of a barge in an area with good surface currents, with similar benefits achieved. The structure can also be utilized in applications such as wind turbines or even in propulsion applications where strength, weight, large scalability and cost are important.

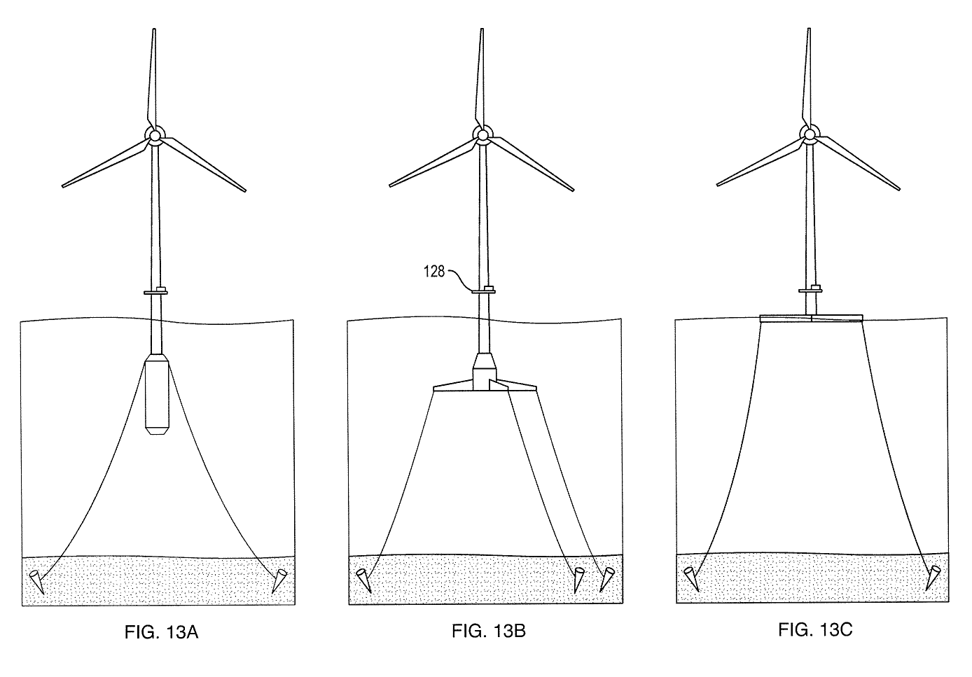

The advantages of the invention described herein will be apparent to those of strong expertise in the fields of hydrokinetic and wind turbines. Reports created by the US National Renewable Energy Laboratory, a division of the US Department of Energy, such as report NREL/CP-500-34874, released in 2003 and titled Feasibility of Floating Platform Systems for Wind Turbines, as well as NREL/CP-500-38776, released in 2007 and titled Engineering Challenges for Floating Offshore Wind Turbines, clearly highlight many of the long standing industry barriers which the present invention solves. FIG. 13 shows some of these legacy platforms, ranging in weight from approximately 500 to 5000 tons, as documented by NREL and others. Even with very large swept areas, approaching 100 m in diameter, this design can be built modularly, assembled at a port near to the deployment site, deployed in the water via on-shore cranes, towed to its deployment site, attached to its mooring lines/umbilical, and submerged to its deployment depth; all with ubiquitous and low cost off-shore oil and gas support vessels.

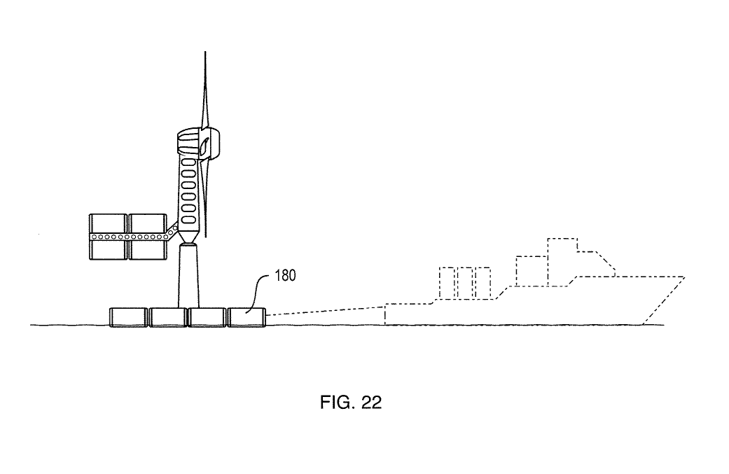

In one embodiment, tow pontoons 180, FIG. 22, which may be rigid or inflatable, are utilized to suspend the legs of the structure below the water's surface, with the turbine blades being just above the water surface. Cables are also utilized to connect these pontoons to the upper portion of the mast for stability during towing. Tow lines can be attached to the front of these pontoons for towing the turbine to its deployment site in a stable and cost effective manner. Once at the deployment site, the main buoyancy cells (bladders) can be inflated, the mooring cables connected, and the pontoons removed. Winching mechanisms, including temporary ones, can be utilized, along with buoyancy control in the turbine structure, to position the full system below the surface of the water, at its operational depth.

For support, the device can be re-surfaced by adjusting ballast and line tensions, again necessitating only low cost (low $1,000's/day), off-shore work boats and possibly ROV's, leveraged from oil and gas support industries. This is in stark contrast to existing hydrokinetic and off shore wind systems, which require highly specialized, scarce and extremely expensive (some greater than $500,000/day) support vessels for deployment and maintenance. Final deployment without any structure at or near the surface significantly reduces the negative effects of wave action, and eliminates surface-visual pollution.

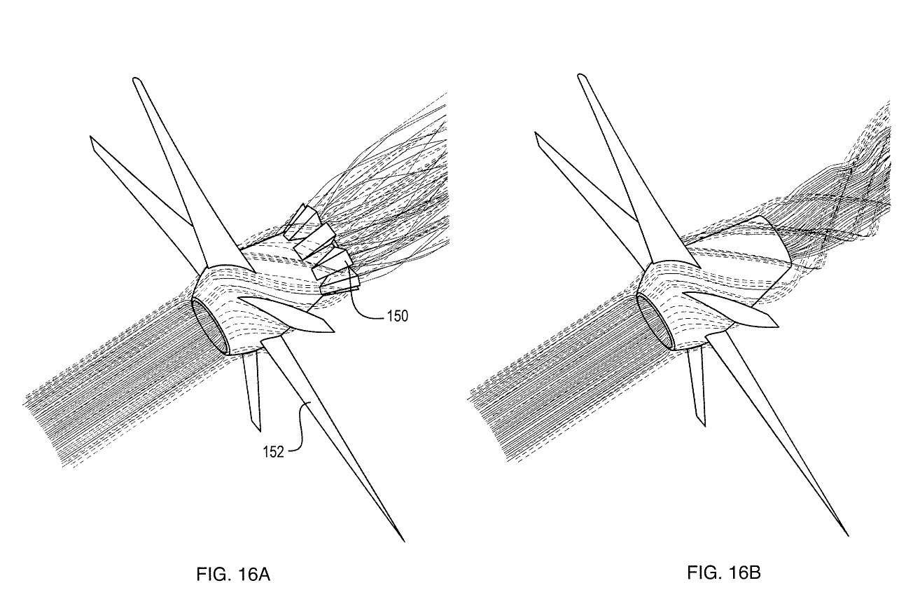

In another embodiment referring now to FIG. 16, the rear of the unducted open center turbine may include hydrodynamic features such as fluting 150, which take advantage of the fluid passing through the center tube of the turbine to enhance the ability of the turbine rotor blades and drive train 152 to extract energy from the passing fluid such as air or water.

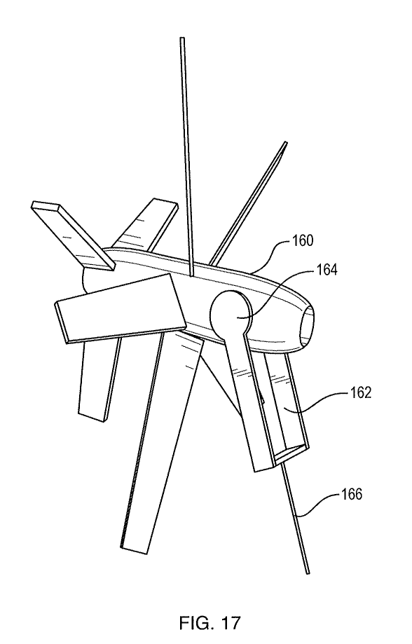

The embodiment of FIG. 17 illustrates the use of additional buoyancy 160 in the mid body, to make the overall structure positively buoyant. In this embodiment, the yoke 162 includes a pivot point 164 that is at the center of drag for the turbine. In other embodiments, the pivot point may be above or below the center of drag. The pivot 164 allows the turbine to remain level while allowing the angle of the yoke 162 to change, which has a positive effect of the system efficiency and stability. The connection member 166 attaching to the yoke may be rigid or it may be flexible, such as utilizing a cable.

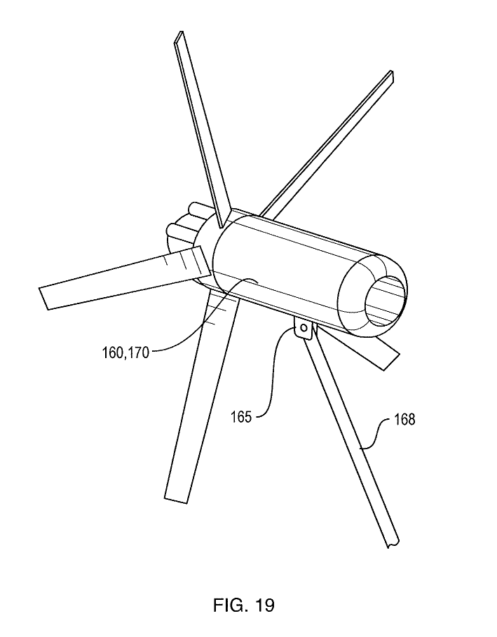

In another implementation shown in FIG. 19, the connection member 168 attaches at a single point 165 under the turbine and pivots. In both the implementation of FIG. 17 as well as FIG. 19, the amount of travel in the pivot joint 164 or 165 may be restricted by various mechanical and other means, in order to limit the range of motion of the turbine relative to the connection members 166 or 168, such as for example, attaching at multiple points on each end in order to restrict movement.

The buoyancy system 160 may include a chamber or device full of a gas such as for example air, or it can be partially or fully flooded, as needed, to maintain the specific amount of buoyancy desired for various operating conditions. In addition, the buoyancy system 160 may have more buoyancy above the pivot point than below it, in order to provide additional stability to the overall system. In some implementations, larger buoyancy chambers may be utilized on the top of the turbine versus on the bottom, in order to provide the additional buoyancy above the pivot point.

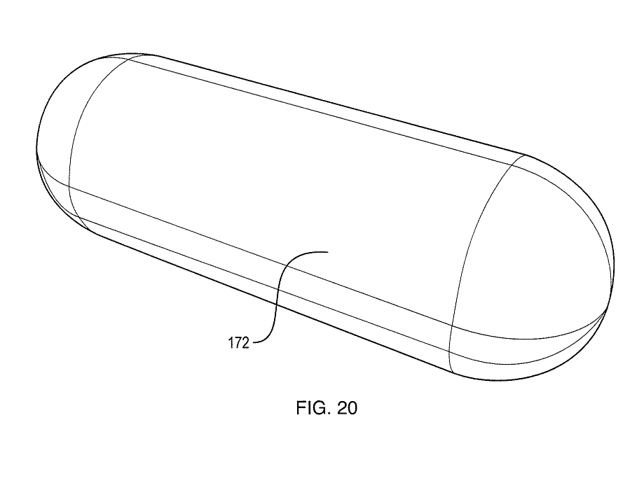

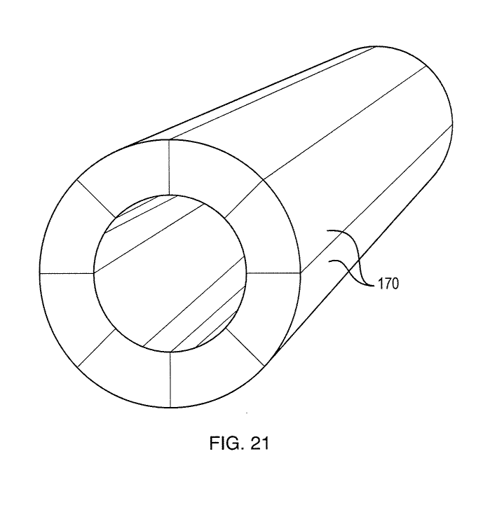

As shown in FIG. 21, the buoyancy may be compartmentalized into 2 or more separate buoyancy chambers 170 in order to increase redundancy and survivability of the structure, as well as to improve manufacturability, deployment, transportation, installation, operation and maintenance of the system. As shown in FIG. 20, the buoyancy chambers may be various shapes 172, as well as various materials such as synthetic membranes, fiber reinforced plastics, as well as thin membrane like or thicker metallic materials such as for example steel. Implementations involving relatively thin materials, under ambient pressure such that there is just enough pressure in the chamber to push the desired amount of water out, are especially suitable, as they are much more cost effective than much thicker pressurized chambers such as the multi hundred ton, two inch thick steel pressure vessel of the MIT/NREL off shore wind turbine described elsewhere in this application.

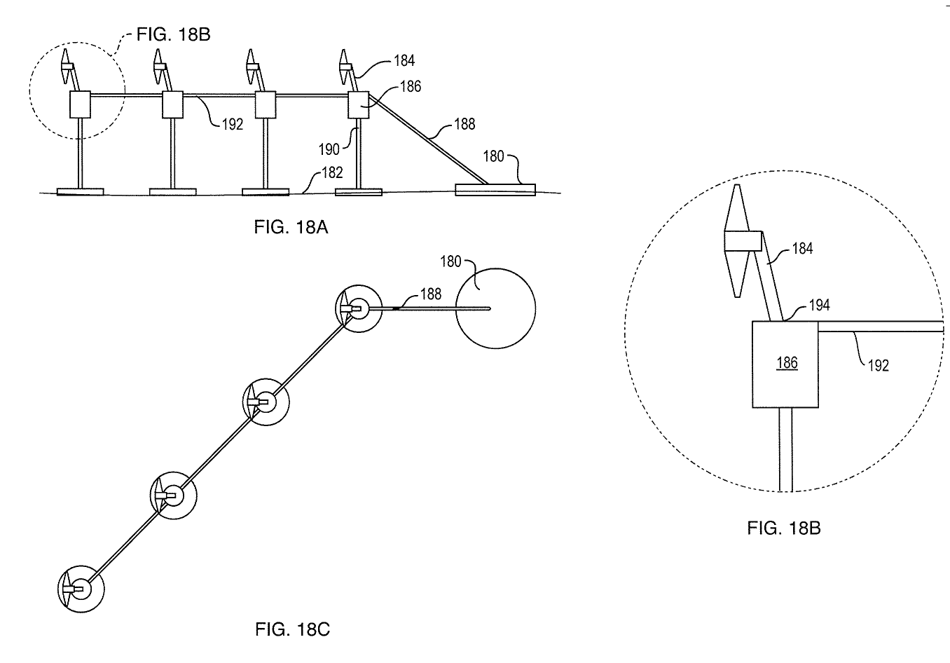

As shown in FIG. 18, one implementation utilizes an upstream anchoring point 180 on the seafloor 182, which is connected via a cable 188 to a buoyant chamber 186 at or before the first turbine 184. This chamber 186 provides a mounting point for the turbine connection such as 166 or 168 to counteract the forces on the turbine that would cause it to move down stream or to otherwise move in unwanted ways. Utilizing the chamber 186 as opposed to just utilizing a single point mooring where a cable such as 190 is attached directly to the connection member such as 166, significantly reduces the amount of overall buoyancy that is needed in the overall system in order to provide the same level of station keeping capability, due to the fact that the cable 188 reduces the need for the buoyancy to carry the full load in canceling out the forces that want to push the turbine downstream.

By offsetting the turbines in the current flow as is shown in the top down view of FIG. 18, the upstream turbine wakes do not impact the performance of the downstream turbines. By connecting the turbines via the chambers 186 in a daisy chain such as by a cable 192 the anchor point 180 provides the same benefits to the downstream turbines that it provides to the first turbine, without having to provide additional cabling and anchor points for each turbine, thereby saving on installation and recurring costs. In addition, power cabling may be run up tension cable 190 and then along tension cables 192, thereby significantly reducing the amount of power cable needed, providing electrical connections to turbines and command and control infrastructure, especially in deep water, versus running it from the seafloor up to each turbine such as would be the case for a single point mooring non-daisy chain mooring system, in addition to significantly reducing the number of sea floor penetrations needed. More advanced implementations of the turbine farm layouts of FIG. 19 will enable for example branching from one turbine to two or more directly downstream of it, in order to take advantage of the force cancellation this causes from one turbine to the others in the array.

The pivot based connection systems of FIGS. 17 and 19, with rigid connection members 166 and 168 and the daisy chain mooring implementation of FIG. 18 provides a dramatic additional reduction in weight and cost, in addition to the cost and weight reductions noted elsewhere in this application. The daisy chain mooring system may be anchored both up and down stream, such as for example for use in bi-directional tidal streams, with the turbines being able to pivot at the connection point 194, here to, utilizing mechanisms which restrict the range of motion of the pivot at 194 in order to prevent the turbine from getting into a positional attitude that could endanger the overall system.

In the daisy chain implementation of FIG. 18, the buoyancy chambers 186 may be host or co-host to various other marine based systems such as wave/wind energy conversion systems and energy storage systems, for which the implementation of FIG. 18 may be particularly cost effective.

Accordingly, the present invention solves numerous deficiencies in the prior art providing a novel and non-obvious hydrokinetic or aero kinetic generating device that makes use of unique structural designs, drive trains, flexible materials and composites in the hybrid design enabling low cost and scalable devices which allows a significant reduction in the system capital costs and deployment costs, dramatically opening up the scope of large, low velocity currents worldwide for use and cost competitive hydrokinetic (or aero kinetic) generation in ocean, tidal currents and rivers, as well as predominantly offshore wind applications.

Most importantly, this invention is particularly useful when applied in a shared platform manner, with a wind turbine on the top and a hydrokinetic turbine on the bottom of the buoyancy platform. In this manner, the cost of the platform is amortized across two turbines, as is the entire supporting infrastructure, making the case for off-shore wind much more viable, in the many locations globally where there is a coincidence of low follow velocity currents and relatively good winds. Similar cost advantage is enabled when sharing the structure among other marine energy systems such as wave and energy storage systems that depend upon large amounts of buoyancy.

While the benefits of one element or another will quickly be obvious to an experienced marine engineer, the particular innovation itself was far from obvious due to the detailed multi-disciplinary COE element analysis needed in order to isolate full life cycle cost drivers and the non-traditional highly multi-disciplinary design approaches and team needed in order to obtain the desired cost/benefit of the present invention.

The present invention is not intended to be limited to a device or method which must satisfy one or more of any stated or implied objects or features of the invention and should not be limited to the preferred, exemplary, or primary embodiment(s) described herein. Modifications and substitutions by one of ordinary skill in the art are considered to be within the scope of the present invention, which is not to be limited except by the allowed claims and their legal equivalents.

1. A hydrokinetic device comprising:
a turbine having a turbine body portion that includes a high strength hollow tube, and configured for allowing a fluid medium to pass through said high strength hollow tube;
a rotor, disposed on and configured for rotation around an exterior high strength, low friction bearing surface of said high strength hollow tube;
one or more blades, each said one or more blades coupled to said rotor;
a main gear, said main gear attached to said rotor; and
one or more generators, mechanically coupled to said main gear.

2. The device of claim 1, further including a buoyancy system, wherein said buoyancy system is configured to provide buoyancy to at least said high strength tube.

3. The device of claim 1, wherein each said one or more blades are coupled to said rotor via a blade shaft configured to fit into a rotor coupling, and wherein said rotor coupling is configured to allow rotation of the blade for pitch control and feathering.

4. The device of claim 1, wherein said one or more generators further include one or more gearboxes.

5. The device of claim 1, wherein each said one or more generators further including buoyancy and wherein said buoyancy renders said one or more generators near neutrally buoyant.

6. The device of claim 1, further including one or more electronics modules, coupled to an electrical bus, and wherein said one or more electronics modules are field replaceable and wherein said one or more electronics modules house one or more electronic components such as power conditioners, voltage regulators, voltage multipliers and control electronics.

7. The device of claim 6, further including a plate positively affixed to said high strength tube, wherein said one or more gearboxes, and said one or more generators and said one or more electronic modules are configured to plug into one or both of an electrical and optical bus which is integrated into said plate, wherein said electrical/optical bus is configured to allow communication between said one or more electronic modules, to create a common umbilical that enables said one or more electronic modules to share power from said one or more generators and connects the turbine to external command and control infrastructure.

8. The device of claim 1, further including a plurality of gearboxes, generators and electronic modules, wherein said plurality of gearboxes, generators and electronic modules provide full redundancy and failure prevention, thereby minimizing onsite maintenance and repair and maximizing system generating up time.

9. The device of claim 8, further including a braking system, wherein said braking system is configured to slow or stop said rotor.

10. The device of claim 8, further including a clutch mechanism, wherein said clutch mechanism is configured to engage or disengage said plurality of generators and said plurality of gearboxes from said main gear.

11. The device of claim 1, wherein said turbine body is fixably coupled to a turbine tower and at least one rotating buoyancy chamber, wherein the turbine tower rotates within a tripod structure and rigidly connects the turbine body to the at least one rotating buoyancy chamber, wherein the force from a flow of fluid on said turbine is directly opposite a force created by said rotating buoyancy chamber.

12. The device of claim 1, wherein said high strength hollow tube features one or more guide vanes located on an internal surface of said high strength tube, said guide vanes configured to provide redirection of said fluid, greater efficiency and counter torque in said turbine.

13. The device of claim 1, wherein said turbine features fluting proximate a rear portion of said high strength tube.

14. The device of claim 1, wherein an inside surface of said rotor is at least partially lined with bearing material, wherein said bearing material is configured to be submerged in said fluid which provides lubrication and wherein said bearing material is selected from one of the group consisting of: wood, synthetics and metal.

15. The device of claim 1, wherein said high strength tube further includes one or more of the following: a sleeve, a spray and other added surface elements, wherein said sleeve, spray or other added surface elements is configured to enhance wear characteristics of said high strength tube.

16. The device of claim 1, wherein said buoyancy system includes one or more buoyancy tanks and a counter rotational ballast located below a center of buoyancy, thereby creating a relatively neutrally buoyant turbine configuration.

17. The device of claim 1, wherein said buoyancy system includes a combination of hydrofoil surfaces and integrated buoyancy tanks configured to provide necessary lift, as well as anti-rotational torque capabilities.

18. The device of claim 1, wherein said buoyancy system is located in a mid portion of the turbine body, wherein said buoyancy system makes said turbine body positively buoyant.

19. The device of claim 1, wherein said buoyancy system is at least partially flooded with a gas.

20. The device of claim 1, further including a yoke with a pivot point, coupled to said turbine body, wherein said pivot point is configured to allow said turbine body to remain level while an angle of said yoke changes, and wherein said buoyancy system features larger buoyancy chambers above said pivot point than below said pivot point, thereby providing additional buoyancy above the pivot point and additional stability.

21. The device of claim 1, wherein said buoyancy system is compartmentalized into two or more separate buoyancy chambers.

22. The device of claim 21, wherein said two or more separate buoyancy chambers are constructed from one or more of the following materials: synthetic membranes, fiber reinforced plastics, thin membrane like metallic material, thicker metallic materials and steel.

23. The device of claim 1, further including an anchoring point located on a seafloor, wherein said anchoring point is connected via a cable to a buoyant chamber.

24. The device of claim 23, further including a plurality of turbines, each of said turbines connected in a daisy chain by said cable.

25. The device of claim 24, wherein said buoyant chamber is configured to host or co-host one or more other marine based systems such as wave/wind energy conversion systems and/or energy storage systems.

26. The device of claim 1, further including a tower mast rigidly connected to the turbine at an intersection point, wherein said tower mast features a hydrofoil shape that is low drag and is configured to accurately position the turbine in the main direction of a flow of said fluid.

27. The device of claim 1, further configured to store energy using processed energy storage liquids or gas compression in tanks, wherein said stored energy can be either exported or reconverted to electricity to be used by said turbine.

28. A hydrokinetic device comprising:
a turbine with a turbine body that includes a high strength tube with a rotor;
one or more blades, fixably coupled to said rotor; and
a networked redundant buoyancy control system, wherein said buoyancy control system includes a plurality of bladders configured to provide lift, said plurality of bladders connected to a structure and configured such that a loss of a single bladder will not compromise stability of said structure or operation of said turbine.

29. The device of claim 28, wherein said plurality of bladders are configured to be filled and deflated by a hose, wherein said hose is connected to a computer controlled gas distribution unit, and wherein by filling a specific bladder with a gas, said specific bladder is inflated and an attitude of said structure is maintained by said computer controlled gas distribution unit, which controls which bladders are inflated and deflated.

30. The device of claim 29, wherein said plurality of bladders are constructed from a long life flexible material selected from the group consisting of: carbon fiber, fiberglass, composite and thin metal.

31. The device of claim 29, wherein said plurality of bladders each have a lengthwise pocket configured to accept placement of a rod, wherein said rod is configured to be locked into a mating mechanism on the platform structure thereby allowing installation and de-installation of the bladders by one or more remotely operated vehicles.
